(19) United States
(12) Patent Application Publication
(10) Pub. No.: US 2025/0322739 A1
(43) Pub. Date: Oct. 16, 2025

(54) REMOTELY OPERATED POWER SUPPLY SYSTEM FOR RADIOS AT A CELLULAR SITE

(71) Applicant: RAYCAP IP ASSETS LTD, Nicosia (CY)

(72) Inventors: Garren MARTEL, Nicosia (CY); Charalampos VOGIATZAKIS, Chania (GR); George VASSILAKIS, Nicosia (CY)

(21) Appl. No.: 18/632,816

(22) Filed: Apr. 11, 2024

(51) Int. Cl. G08B 21/18; H02H 7/20

(52) U.S. Cl. CPC G08B 21/185; H02H 7/20

(57) ABSTRACT

A remotely controlled system for powering remote radio heads (RRHs) comprises a base protection unit (BPU) located at a base location and is coupled to one end of a power cable having a plurality of DC circuits. The BPU has a user interface to receive a user command to turn on/off a designated RRH, and to transmit a command signal to implement the command. A top protection unit (TPU) is located proximate to the RRHs and coupled between a second end of the power cable and the RRHs to power the RRHs. The TPU comprises i) a power distribution circuit connecting individual DC circuits to groups of the RRHs, ii) a set of motorized circuit breakers coupled between the power distribution circuit and the plurality RRHs, and iii) a module that receives the command signal from the BPU and switches on/off the motorized circuit breaker connected to the designated RRH.

### BACKGROUND

In current generation wireless communications systems, referred to as distributed antenna systems (DAS), distributed DC radio systems, remote radio heads (RRH), 4G and long term evolution (LTE) cellular communication systems, commonly locate the radios next to the antennas on a tower outside of a base communications shelter. The radios at the tower top (or at rooftops) are supplied by power from the base shelter. A typical site configuration is to provide a DC distribution (through multipole circuit breakers) at the base location that uses individual DC circuits to feed each of the radios located at the tower top. This enables the user to manually switch on and off each radio independently from the base of the site.

Each DC circuit comprises two conductors: i) a power cable (e.g., at −48 volts DC) from a power supply at the base, and ii) a return (RTN) cable back to the power supply located in a shelter where the AC/DC rectifiers are located. A typical site may have 36 radios (12 radios per sector), requiring 36 DC circuits. Typically, the DC circuits (each represented by two conductors) are carried up the tower using six trunk cables, each with 12 conductors for the DC circuits to power the radios. Additionally, towers may host several different radio/antenna combinations, thus providing an issue for routing multiple DC link cables to fit the radios and protecting the connections from overvoltage.

In this configuration, an over voltage protection (OVP) system is used at the base after the power distribution to protect the circuit breakers from surges arriving from the conductors of the trunk cable. The OVP system uses two protection modules per DC circuit connected between −48 Vdc to RTN and RTN to ground. At the tower top there is typically a top OVP system where the trunk cables are terminated. The top OVP system also includes surge protection on each DC circuit, in the same way as at the base OVP system, to protect the radios from direct lightning strikes at the tower top. Each Radio is fed by power jumpers from the top OVP unit to the Radios.

Although this solution works for its intended purpose, the solution is not optimal. The present configuration of the power system can be in some cases inefficient in terms of power consumption due to energy dissipated on the trunk cables that are used to feed the radios from the base of the site, which can increase the cost of the power distribution system. In addition, the trunks typically comprise copper conductors, which are relatively heavy. Due to the number of conductors and the number of cables required to power the radios, the weight of the trunks can increase the difficulty of routing the trunks up to the tower top, resulting in increased installation costs.

### BRIEF DESCRIPTION OF THE DRAWINGS

The included drawings are for illustrative purposes and serve to provide examples of possible structures and operations for the disclosed inventive systems, apparatus, methods, and computer-readable storage media. These drawings in no way limit any changes in form and detail that may be made by one skilled in the art without departing from the spirit and scope of the disclosed implementations.

FIG. 1A is a diagram illustrating a telecommunication power supply system for radio heads (RRHs) according to the disclosed embodiments.

FIG. 1B is a diagram illustrating the BPU and TPU in further detail.

FIG. 1C is a diagram illustrating an enclosure of the TPU.

FIG. 1D is a diagram illustrating an enclosure of the BPU.

FIG. 2A is a flow diagram of a process performed by the BPU when communicating to each installed TPU via communication links.

FIG. 2B is a flow diagram of a process performed by each TPU when communicating to the BPU via communication links.

FIG. 3A is a diagram illustrating a communication implementation between the BPU and each installed TPU.

FIG. 3B is a diagram illustrating a data packet format for passing messages between the BPU and the TPUs.

FIG. 4 is an electrical diagram of a remotely operated power supply system for radios at a cellular site.

### DETAILED DESCRIPTION

The disclosed embodiments relate to methods and systems for providing a remotely operated power supply system for radios at a cellular site. The following description is presented to enable one of ordinary skill in the art to make and use the invention and is provided in the context of a patent application and its requirements. Various modifications to the exemplary embodiments and the generic principles and features described herein will be readily apparent. The disclosed embodiments are mainly described in terms of particular methods and systems provided in particular implementations. However, the methods and systems will operate effectively in other implementations. Phrases such as “one embodiment” and “another embodiment” may refer to the same or different embodiments. The embodiments will be described with respect to systems and/or devices having certain components. However, the systems and/or devices may include more or less components than those shown, and variations in the arrangement and type of the components may be made without departing from the scope of the invention. The disclosed embodiments will also be described in the context of particular methods having certain steps. However, the method and system operate effectively for other methods having different and/or additional steps and steps in different orders that are not inconsistent with the exemplary embodiments. Thus, the disclosed embodiments are not intended to be limited to the embodiments shown, but is to be accorded the widest scope consistent with the principles and features described herein.

The disclosed embodiments relate to a system for remotely controlling a power supply system for a plurality of remote radio heads (RRHs) at a cellular site. According to the disclosed implementations, the system includes a power cable comprising a plurality of DC circuits, a base protection unit (BPU) located at a base location coupled to one end of the power cable, and a top protection unit (TPU) located proximate to the plurality of RRHs and coupled between a second end of the power cable and the plurality of RRHs.

Rather than locate a power distribution of DC circuits at the base location, the disclosed implementations locate the power distribution of DC circuits in the TPU at the top location, and an operator remotely controls the RRHs from the BPU at the base location. The BPU comprises a base communication module comprising a user interface configured to receive a user command to turn on or off a designated RRH, where the base communication module is configured to transmit a command signal to implement the command. The TPU comprises a power distribution circuit connecting individual ones of the plurality of DC circuits to individual sectors or groups of the plurality of RRHs. The TPU further includes a top communication module, and a set of motorized circuit breakers is coupled between the power distribution units and the plurality RRHs. Responsive to the top communication module receiving the command signal from the base communication module, the TPU switches on or off a particular one of motorized circuit breakers connected to the designated RRH.

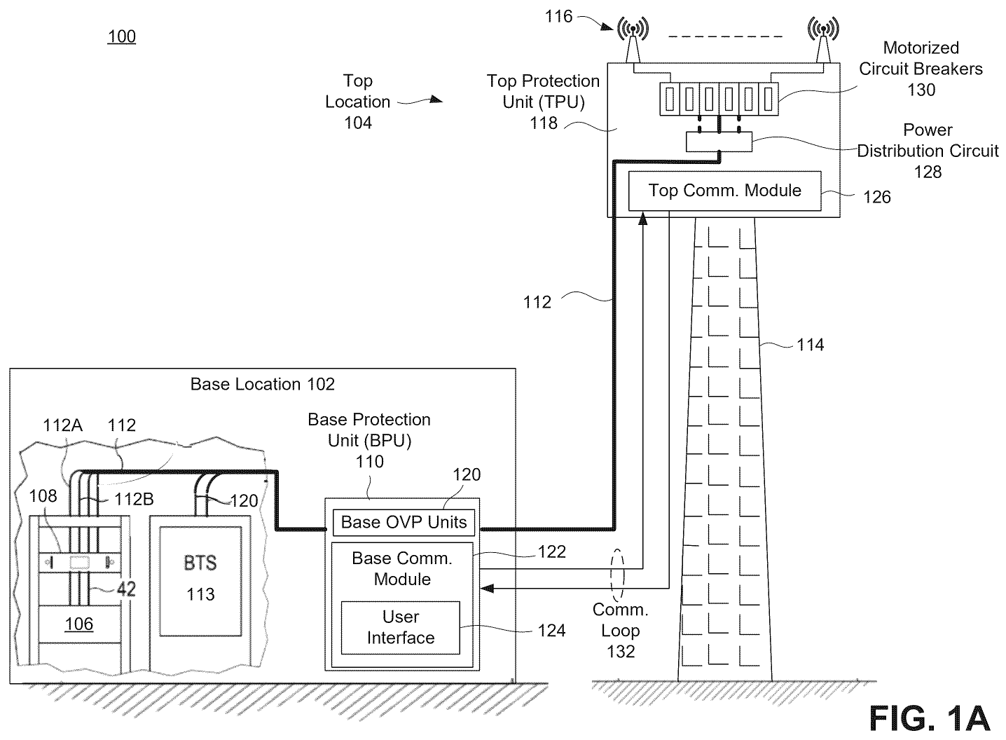

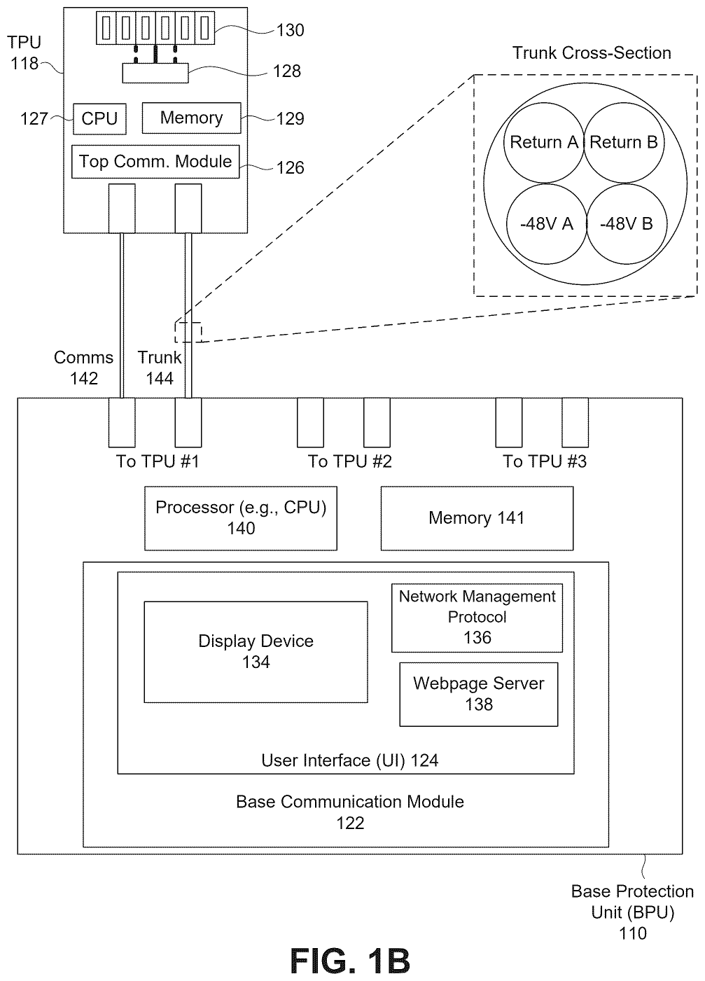

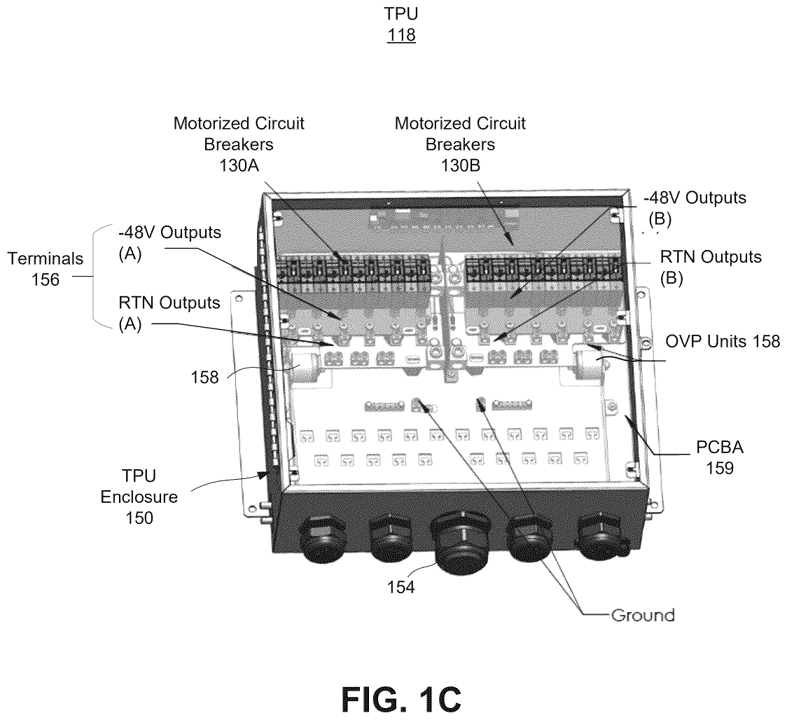

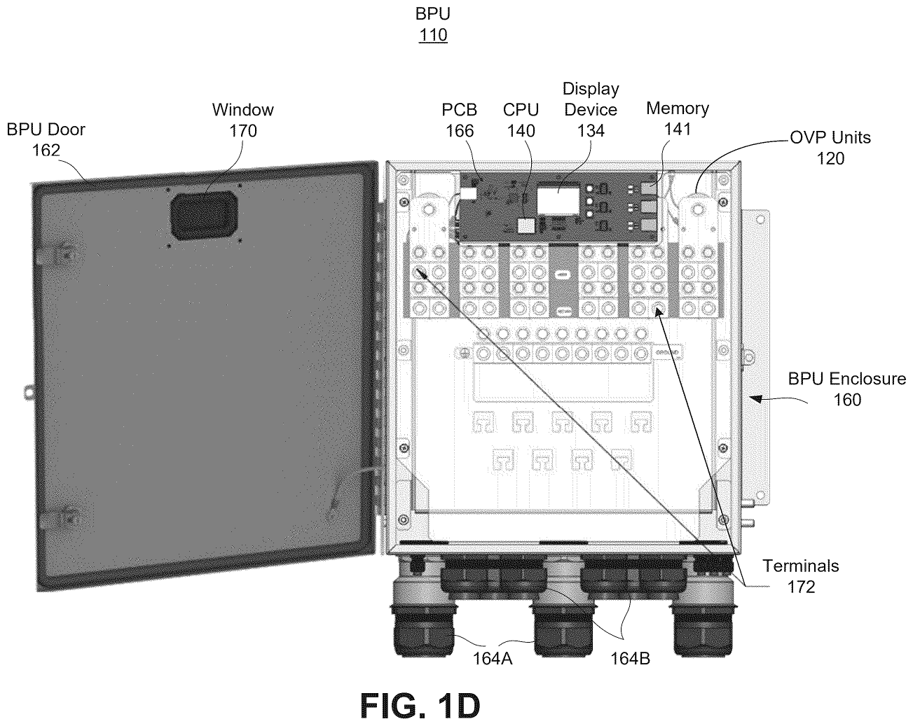

FIG. 1A is a diagram illustrating a telecommunication power supply system for radio heads (RRHs) according to the disclosed embodiments. The power supply system 100 comprises a base location 102 and a top location 104. The base location 102 may comprise any structure that includes a direct current (DC) power system 106, a base suppression unit 108, and a bottom protection unit (BPU) 110 connected to a base end of a DC power cable 112 (hereinafter power cable 112). Base suppression unit 108 may be connected to the local ends of power cable 112 relatively close to DC power system 106. Examples of base suppression units are described in U.S. Pat. No. 10,181,717 which is incorporated by reference in its entirety. Base location 102 may optionally include a base transceiver station (BTS) 113, also referred to herein as a baseband unit, which is connected to the RRHs 119 through fiber optic cables. In one embodiment, the power cable 112 and fiber optic cables may be run together through a hybrid trunk cable (not shown).

DC power system 106 of the base location 102 powers the RRHs 116 in the top location 104 through the connection with the power cable 112. In one implementation, power cable 112 includes sets of −48 DC volt power cables 112A, return power cables 112B, and associated ground cables (not shown). In one implementation, each set of −48 DC volt power cables 112A, return power cables 112B, and ground cables may be referred to as a DC circuit and may be placed or arranged into one or more trunk cables that are carried within the power cable 112. In an alternative implementation, the trunk cables may be routed to the top location 104 individually, without the use of a single power cable 112 containing all the trunk cables.

The power cable 112 is routed out of the structure of the base location 102 to a top protection unit (TPU) 118. The top location 104 may comprise any structure, such as tower 114 or a rooftop, where the remote radio heads (RRHs) 116 are located.

According to the disclosed embodiments, the system 100 may comprise one BPU 110 and one or more TPUs 118. The BPU 110 may comprise base over voltage protection (OVP) units 120, a base communication module 122, and a user interface (UI) 124. The BPU 110 is coupled to the power cable 112, and the OVP units 120 electrically protect the BPU from overvoltage situations. The BPU 110 maintains active control of each installed TPU 118 through base communication module 122.

TPU 118 is located and installed at the top location 104, e.g., attached to tower 114 or a building roof proximate to RRHs 116. The TPU 118 is coupled between a remote or second end of the power cable 112 (and optionally fiber optic cables) and the RRHs 116. The TPU 118 provides for the connection and distribution of the power cable 112 to jumpers cables (not shown) that are coupled to the RRHs 116.

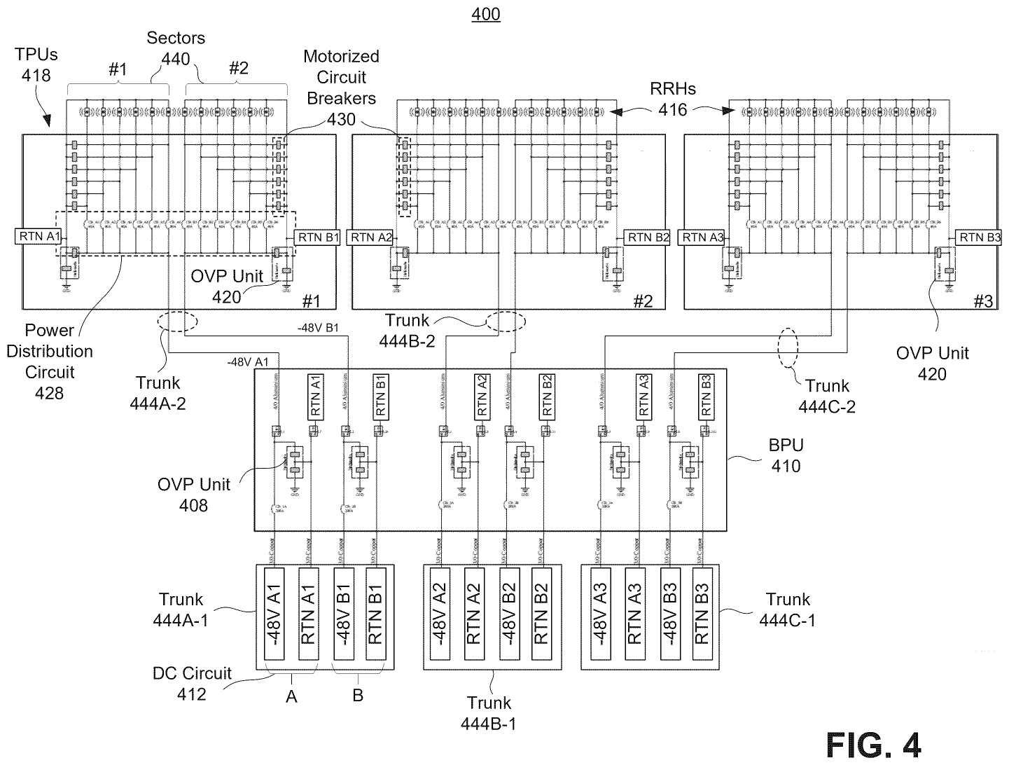

The TPU 118 may comprise a top communication module 126, DC power distribution circuit 128, and motorized circuit breakers 130. As described in more detail, below, the TPU 118 may also provide integrated OVP modules/units 420 (FIG. 4) that protect the RRHs 116 from lighting strikes.

The DC power distribution circuit 128 is coupled to the top or remote end of the power cable 112 and distributes individual DC circuits in one or more trunks of the power cable 112 to individual sectors 440 (FIG. 4) of RRHs 118. The DC power distribution circuit 128 may provide outlets or terminals needed to power the RRHs 116.

Conventionally, power distribution circuits and manual circuit breakers are located at the base location. This allows the user to power up and power down any of the RRHs from the base location. One challenge with locating the power distribution circuit and circuit breakers at the top location 104 is that powering up or down the radios would require an operator to climb the tower and manually trip the circuit breakers or disconnect the power. Otherwise, the power must be disconnected from the circuit breakers from the base location, shutting down the whole site, which is not a viable option. Another challenge is that if a circuit breaker trips for any reason, the operator would be forced to climb the tower to examine the circuit breakers to determine whether a short-circuit or overload condition occurred.

The disclosed embodiments solve these challenges and enable the installation of the DC power distribution circuit 128 and circuit breakers at the top location 104. This is accomplished by providing a communication loop 132 between the BPU 110 and the TPU 118 for remote control of the RRHs 116 from the base, and by providing the TPU 118 with motorized circuit breakers 130.

The base communication module 122 of the BPU 110 comprises a user interface configured to receive a user command to turn on or off a designated RRH. The user commands may be received by the BPU 110 from the operator either locally at the BPU 110 through a display device of the UI 124 or remotely over a network. The base communication module 122 is further configured to transmit a command signal to the top communication module 126 of the TPU 118 for remote control of the RRHs based on the commands.

The top communication module 126 of the TPU 118 communicates with the base communication module 122 via a wireless or wired interface. The top communication module 126 receives commands from the base communication module 122 as well as transmits status information to the base communication module 122, forming communication loop 132, as shown in FIG. 1A.

In the TPU 118, the motorized circuit breakers 130 are coupled between the DC power distribution circuit 128 and the RRHs 118. Motorized circuit breakers 130 are electrically operated devices that typically protect the DC circuits from overcurrent or a short circuit by opening or closing the circuit when a predetermined level of current is reached. However, according to another feature of the disclosed embodiments, the motorized circuit breakers 130 are used to remotely turn on/off the RRHs 116 based on the user commands relayed by the top communication module 126 from the base communication module 122. That is, the top communication module 126 receives the user command signal from the base communication module 122 to turn on or off a designated RRH, and in response, the TPU 118 switches on or off the particular motorized circuit breaker connected to, or associated with, the designated RRH. Additionally or alternatively, the top communication module 126 of the TPU 118 may be enabled to receive the user commands directly from a network device located at a remote location through a network connection.

FIG. 1B is a diagram illustrating the BPU 110 and TPU 118 in further detail, where like components of FIG. 1A have like reference numerals. Referring to both FIGS. 1A and 1B, in addition to the TPU's top communication module 126, the DC power distribution circuit 128 and motorized circuit breakers 130, the TPU 118 further includes a processor 127 (e.g., a CPU) and memory 129. Memory 129 stores software instructions, which when executed by the processor 127 causes the processor to carry out the functions of the TPU 118 as described herein. The memory 129 also stores the current status of the motorized circuit breakers 130 and the like.

BPU 110 includes UI 124, which in one implementation may be part of the base communication module 122. Alternatively, the UI 124 may be a standalone component or be a part of another component, but controlled by the base communication module 122. The UI 124 handles all interactions with users. For example the UI 124 displays system information and accepts user commands to receive status data, provide system settings for different configurations as well as turn on/off individual RRHs 116.

The UI 124 may include a display device 134, such as an LCD and the like for handling user interactions. In one implementation, the UI 124 may include an optional keyboard (not shown). The display device 134 may be implemented as a touchscreen device or as a display screen and a touchpad or keyboard. Additionally or alternatively, the UI 124 can also handle user interactions through a network connection (e.g., Internet) using a network management protocol 136 or via an embedded webpage provided by a webpage server 138. Example types of network management protocols include Simple Network Management Protocol (SNMP) and Internet Control Message Protocol (ICMP), for example. The UI 124 may be controlled by a processor 140, such as a central processing unit (CPU), a microprocessor, a microcontroller, and the like. Memory 141 stores software instructions, which when executed by the processor 140 causes the processor to carry out the functions of the BPU 110 as described herein.

According to one feature of the disclosed embodiments, through UI 124 the BPU 110 is configured to receive user commands from an operator to turn on or off designated RRHs 116 (and/or motorized circuit breakers 130) independently, and to view status data from the TPU 118. The BPU 110 is also configured to transmit corresponding command signals to the TPU 118 to implement the user commands.

Multiple TPUs 118 can be connected to individual trunks within power cable 112 or to individual power cables 112. FIG. 1B shows that BPU 110 may be connected to one multiple TPUs 118 (designated as TPU #1, TPU #2, and TPU #3) through respective pairs of communication links (comms) 142 and trunks 144. The communication link 142 may be used for the BPU 110 to transmit command signals to the TPU 118 and to receive status data from the TPU 118. The communications link 142 may be included in trunk 144 or may be separate from the trunk 144.

Also shown in FIG. 1B is an enlarged view of a trunk cross-section showing that each trunk 144 includes two DC circuits, each comprising a pair of −48V and return lines. According to one aspect, the DC circuits in each trunk 144 comprise aluminum conductors, rather than copper, to save weight, and costs and to ease the installation of the trunks to the top location. In one implementation, each trunk may be constructed of 12 gauge, corrosion-resistant, powder-coated, aluminum. However, the cross-section of the trunk cable conductors has to be increased to reduce the losses on the cable, compared with a far more expensive, and heavy alternative using copper conductors.

FIG. 1C is a diagram illustrating an enclosure of the TPU 118, and FIG. 1D is a diagram illustrating an enclosure of the BPU 110. Referring to FIG. 1C, enclosure 150 of the TPU 118 includes a top wall, a bottom wall, two side walls, and a back wall that form an interior. A TPU door (shown removed) may comprise a front wall of TPU enclosure 150. The TPU 118 is configured to connect to ends of one or more trunk cables 144 (FIG. 1B). The TPU enclosure 150 includes a clamping mechanism 154, optionally disposed through the bottom wall of the enclosure 150, which is configured to receive trunk cable 144. The same or different clamping mechanism 154 may be used to receive communication link 142.

The interior of the TPU 118 further includes terminals 156 for −48V DC outputs (A/B) and return outputs (A/B) to the RRHs. Two sets of motorized circuit breakers 130A and 130B that control different sectors of the RRHs are connected to terminal 156. In one implementation, the number of motorized circuit breakers 130 is the same as the number of RRHs in a sector, which in this example is six. Respective over voltage protection (OVP) units 158 (e.g., Strikesorb −48V) are connected to each set of motorized circuit breakers 130A and 130B to protect from lightning strikes. The TPU 118 further includes a printed circuit board assembly (PCBA) 159 containing the processor 127 and memory 129 (FIG. 1B) along with any other suitable electronic components.

In one implementation the TPU 118 may have dimensions of approximately 20-25″ in both width and height and 6-8″ in depth.

Referring to FIG. 1D, BPU enclosure 160 also includes a top wall, a bottom wall, two side walls, and a back wall that form an interior. A hinged door 162 may comprise a front wall of the BPU enclosure 160. The BPU enclosure 160 includes a first set of one or more clamping mechanisms 164A configured to receive power cable 112 (FIG. 1A) comprising one or more trunk cables 144, and a second set of one or more clamping mechanisms 164B configured to route the one more trunk cables 144 to an exterior of the enclosure 160 for connection with the installed TPUs 118. The same or different clamping mechanisms 164A and 164B may be used to receive communication link 142. In one implementation, clamping mechanisms 164A and 164B may be disposed through the bottom wall of BPU enclosure 160, but may be disposed through any of the walls.

The interior of BPU 110 enclosure includes a printed circuit board (PCB) 166 on which display device 134, processor 140, and memory 141 may be mounted. The memory may be used to program instructions that are executed by the processor 140. According to one aspect of the disclosed embodiments, the hinged door 162 may include a window 170 so that display device 134 is visible without the need for an operator to open the hinged door 162. The exterior side of hinged door 162 may include a hinged cover (now shown) that can be opened or closed over window 170 to protect window 170 as needed.

The interior of the BPU further includes terminals 172 for −48V DC outputs (A/B) and return outputs (A/B). Terminals 172 may have two positions, one used as an input and the other used as an output. An individual voltage protection (OVP) unit 120 is connected to each DC circuit contained in the power cable (and/or trunks). In one implementation the TPU 118 may have dimensions of approximately 18-21″ in both width and height and 5-8″ in depth.

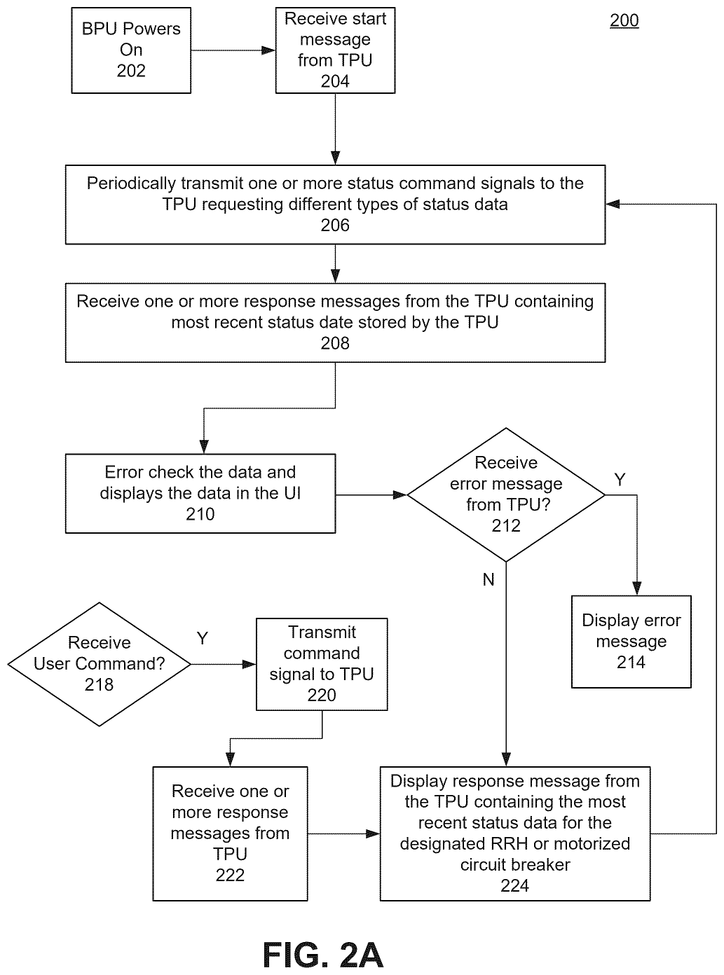

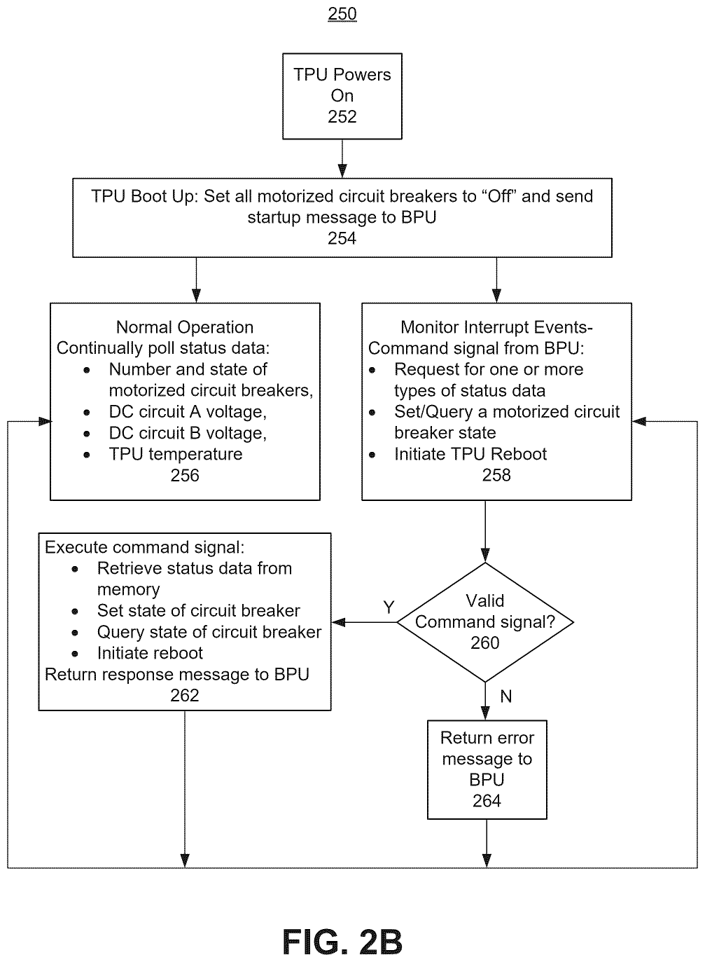

FIG. 2A is a flow diagram 200 of a process performed by the BPU 110 when communicating to each installed TPU 118 via communication links 142. The process may be performed by processor 140 of the BPU 110 and begins once the BPU 110 is powered on (block 202). The BPU 110 then receives a startup message back from the TPU 118 (block 204). When the TPU 118 powers on, all the motorized circuit breakers 130 may be initially set to off by default.

In operation, the BPU 110 maintains active control of each installed TPU 118 and its motorized circuit breakers 130 via communication loop 132. There are two types of electronic communication between the BPU 110 and TPU 118, status communication and control communication. Status communication refers to the BPU 110 transmitting a status command signal that requests some type of status information from the TPU. Control communication refers to the BPU 110 transmitting a control command signal that relays a user command to set the status of one or more designated circuit breakers (open/closed).

The BPU 110 periodically polls the TPU 118 by transmitting one or more status command signals to the TPU requesting different types of status data from the TPU 118 (block 206). For example, every 1-5 seconds, the BPU 110 may transmit one or more status command signals to the TPU 118 requesting one or more of the following different types of status data (each type of status data is periodically polled by each TPU 118 and stored in memory):
i. the number of configured tower devices and the number of motorized circuit breakers,
ii. the current state of each of the motorized circuit breakers (open/closed),
iii. −48 voltage value of each DC circuit input to the TPU,
iv. the ambient temperature of the TPU (e.g., −40° C. to 125° C.), and
v. the status of other tower devices (online/offline).

Responsive to the status command signal, the BPU 110 receives one or more response messages from the TPU 118 containing the most recent status data stored by the TPU 118 (block 208). The BPU 110 error checks the data and then displays the data in UI 124 (block 210). Responsive to receiving an error or alarm message from the TPU 118 (block 212), e.g., an invalid checksum, the BPU 110 displays the error message to notify an operator/user (block 214). The BPU 110 may display the error message on display device 134 and/or on a webpage via webpage server 138 (FIG. 1B). Responsive to not receiving an error message, the BPU 110 receives and displays one or more response messages from the TPU 118 containing the most recent status data for the designated RRH or motorized circuit breaker stored by the TPU 118 (block 222).

Responsive to periodically receiving a user command via the UI 124 to turn on/off a designated RRH 116 or motorized circuit breaker or to get status information (block 218), the BPU 110 transmits a corresponding command signal to the TPU (block 220). The BPU can receive the user command to change the state of one of the RRHs 116 or motorized circuit breakers 130 from the operator/user using one of two methods. The first method is to receive the command through entries made into the display device 134 by the operator. For example, if the operator is present on-site, the operator uses the display device 134 to navigate to a displayed control menu to select or enter the designated RRH or motorized circuit breaker and select a desired state for the circuit breaker. The second method is to receive the user command through a network management protocol 136 (e.g., SNMP) or via an embedded webpage in which the operator logs in to the BPU 110 and remotely changes the state of the designated motorized circuit breaker.

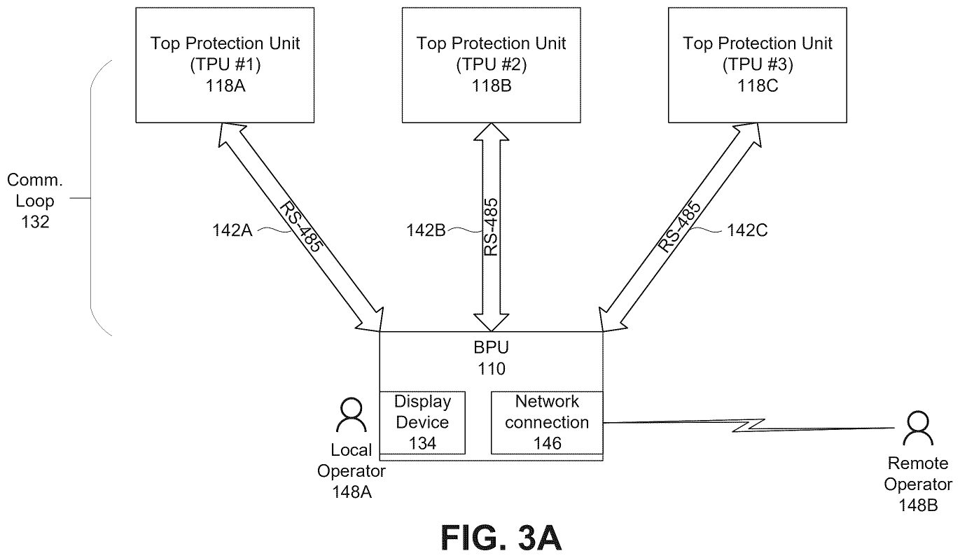

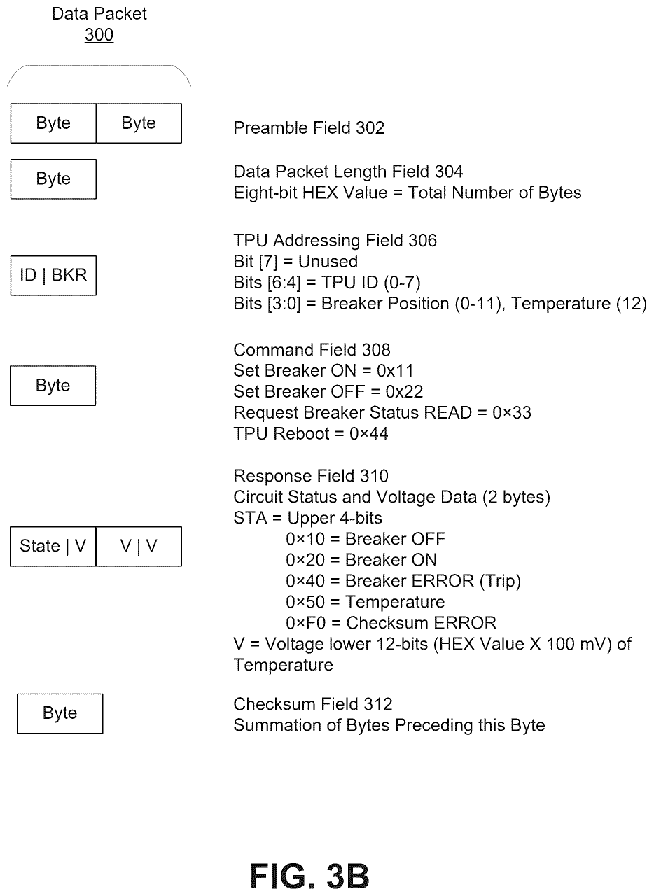

The BPU 110 transmits the command signal by creating a data packet (FIG. 3A), populating fields of the data packet (including the specified command), and transmitting the data packet to the TPU.

Responsive to the TPU executing the command signal, the BPU 110 receives one or more response messages from the TPU 118 (block 222). The BPU 110 displays the one or more response messages from the TPU 118 containing the most recent status data for the designated RRH or motorized circuit breaker stored by the TPU 118 (block 224). If for example, the command were to change the state of a designated motorized breaker, the response message would include the state change of the designated motorized breaker.

FIG. 2B is a flow diagram 250 of a process performed by each TPU 118 when communicating to the BPU 110 via communication links 142. In one implementation, the process may be performed by the processor 127 of each TPU. Responsive to powering on and booting up (block 252), the TPU 118 sets all motorized circuit breakers to “Off” by default, and sends a startup message to the BPU 110 (block 254).

Thereafter, the TPU enters normal operation and continually polls and stores status data at set intervals, where the status data includes one or more of the number and state of the motorized circuit breakers, voltage of one or more DC circuits (e.g., DC circuit A voltage, DC circuit B voltage), and TPU temperature (block 256). This status data is stored in memory 129 until requested by the BPU at least in part to maintain an active image of the expected state of each breaker. New status data may be sampled periodically at intervals of every 0.5-2 seconds for example. The TPU maintains a memory of the commanded circuit breaker state and may poll the circuit breaker itself to determine the actual state. If these two don't match, the TPU may report an error state.

The TPU also monitors for interrupt events in the form of receiving a command signal from the BPU (block 258). Example types of command signals received may include a request for one or more types of status data, to set or query a motorized circuit breaker state, and to initiate a TPU reboot.

Responsive to the TPU receiving a command signal (block 258), the TPU validates the received command signal (block 260) and executes the received command signal (block 262).

Validating the command signal may include inspecting a data packet comprising the command signal by verifying start bytes, verifying packet length, and verifying a checksum. Responsive to the TPU determining that the command signal is invalid, the TPU returns an error message to the BPU (block 264).

Depending on the type of command signal received, the TPU may execute the command to: retrieve the type of requested status data from memory, set the state of a designated motorized circuit breaker, query the state of the designated motorized circuit breaker, or initiate a TPU reboot. If the TPU receives a command signal to set the state of a specific motorized circuit breaker to “On”, the TPU updates its memory to match the expected state for the designated motorized circuit breaker. Each motorized circuit breaker has a “State” signal that is observed by the TPU processor. This breaker state may represented as either “Off” or “On”. When polled, if the state of the motorized circuit breaker does not match the expected state stored in the TPU memory, an error has occurred (e.g., when a designated motorized breaker fails to respond to the command signal). This status may be relayed to the BPU when the TPU is next polled as an error or alert message. The last step when executing the command signal is to return a response message by creating a data packet (FIG. 3A), populating fields of the data packet (including any requested data), and transmitting the data packet to the BPU.

After executing a command or returning an error or alarm message to the BPU, the TPU continues normal operation (block 256) and monitoring for interrupt events (block 258).

FIG. 3A is a diagram illustrating a communication implementation between the BPU 110 and each installed TPU 118. In one implementation, communication links 142A, 142B, and 142C between the BPU 110 and each TPU 118A, 118B, 118C, may be implemented using a serial communications system such as RS-485 (also referred to as also known as TIA-485(-A) or EIA-485). In this implementation, communications links 142 represent physical links. In one implementation, the communications links 142 may comprise shielded twisted-pair cables and RF filtering to aid the reliability of communication between the BPU 110 and the TPU 118 within high RF fields. In another implementation, communication links 142A, 142B, and 142C between the BPU 110 and each TPU 118 may represent a wireless connection (e.g., Wi-Fi and the like).

The BPU 110 receives commands that a local operator 148A enters through display device 134 or receives commands that a remote operator 148B sends from a remote location external to the base location 102. The BPU 110 enables the entry of remote commands via network connection 146. Network connection 146 may refer to a hardwired connection to the Internet (e.g., Ethernet) or through a wireless connection (e.g., Wi-Fi).

According to another aspect of the disclosed embodiments, when messages between the BPU 110 and the TPUs 118 are transmitted via serial communication (e.g., RS485), a unique communication data packet structure is used that minimizes data transmission size while maintaining error checking and providing a level of security with encrypted messages. In this implementation, each message, whether a command from the BPU or a response from a TPU comprises a data packet of 6-10 bytes of data, and in one specific implementation is limited to 8 bytes of data.

FIG. 3B is a diagram illustrating a data packet format for passing messages between the BPU and the TPUs 118. According to one example implementation, data packet 300 comprises a preamble field 302, a data packet length field 304, a TPU addressing field 306, a command field 308, a response field 310, and a checksum field 312.

The preamble field 302 comprises the first two bytes of data packet 300 and is used to allow a receiver to synchronize to the beginning of a message. If the bytes comprising the preamble field 302 are not received, the remaining data is out of order and would result in potentially corrupted data.

The data packet length field 304 comprises the third byte of the data packet 300 and used to indicate the total number of bytes transmitted in the data packet 300. In one implementation, the data packet length field 308 contains an 8-bit HEX value indicating the total number of bytes, which is number eight by default.

The TPU addressing field 306 comprises the fourth byte of the data packet 300 and serves as a method for the BPU 110 to address TPUs 118 that share a communication link 142. The top half of the byte designates the TPU ID (e.g., 0-7), and the bottom half of the byte designates which motorized circuit breaker 130 position (e.g., 0-11) or TDU temperature is being accessed.

The command field 308 comprises the fifth byte of the data packet 300 and is issued by the BPU 110 and handled by the addressed TPU 118. The data in the command field 308 along with the data in tower addressing field 306 designate one of the motorized circuit breaker 130 and the state (On/Off) to which it is being set. The data in the command field 308 can also be used for the BPU 110 to query the TPU 118 for the status of the motorized circuit breaker 130 designated in the TPU addressing field 306 or used to force the TPU designated in the TPU addressing field 306 to perform a system reboot/reset.

The response field 310 comprises the sixth and the seventh bytes of the data packet 300 and is used by the designated TPU to communicate response data to the BPU. When a command is issued from the BPU 110 to a TPU 118, the response field 310 is filled with zeros. When the TPU 118 responds with requested data, the top half of byte six is a bit state code of the response to the command request. If the state of the designated motorized circuit breaker is requested in the command field 308, the state code contains a value indicating the state (e.g., Off, On, or Error (trip)). If a temperature reading was requested in the command field 308, the state code contains the temperature value. The lower half of byte six and all of byte 7 is used to contain a hexadecimal value of the measured voltage associated with the designated motorized circuit breaker requested in byte four of the TPU addressing field 306.

The checksum field 312 comprises the final byte of the data packet 300 and is used as a form of cyclic redundancy check. The checksum field 312 contains a value determined by adding all the data bits from the previous seven bytes. This checksum is important to the system as it provides a method for both the BPU 110 and the TPU 118 to verify that all information was received. If the value in the checksum field 312 does not match the checksum calculated by the receiver, the data packet 300 is determined to be corrupted and may be requested to be resent.

FIG. 4 is an electrical diagram of the remotely operated power supply system for radios at a cellular site. In this implementation, power supply system 400 comprises bottom protection unit (BPU) 410 located at a base location and up to three top protection units (TPUs) 418 (#1, #2, & #3) located at a top location. Each of the TPUs 418 may power up to 12 RRHs 416, for a total of 36 RRHs 416 for the system. The RRHs 416 in each of the TPUs 418 are grouped into two sectors 440 (#1 and #2) of six RRHs.

Input to the BPU 410 is a set of input trunks 444A-1, 444B-1, and 444C-1. Each of the input trunks includes two sets of DC circuits 412 (A & B), for a total of six DC circuits 412. Each of the DC circuits 412 comprises a −48V DC cable and a return cable. For example, trunk 444A-1 includes DC circuit A and DC circuit B. DC circuit A includes −48V A1 and RTN A1, while DC circuit B includes −48V B1 and RTN B1. Each DC circuit 412 is connected to a respective over voltage protection (OVP) unit 408 in the BPU 410 that protects downstream circuitry from damage due to excessive voltage.

In one implementation, the −48V DC and return cables of each DC circuit 412 comprise copper, e.g., 3/0 copper wire. The BPU 410 connects the first set of input trunks 444A-1, 444B-1, and 444C-1 to a set of output trunks 444A-2, 444B-2, and 444C-2 that are routed externally to the top location as input to respective ones of the TPUs 418.

According to one aspect of the disclosed embodiments, the power distribution circuit 428 in each of the TPUs 418 provides independent DC distributions, one per independent DC circuit within a trunk. The output of each DC distribution is connected to motorized circuit breakers 430 that feed RRHs 416 in each sector 440, with individual motorized circuit breakers 430 connected to, and controlling, individual RRHs 416. In one example implementation, power distribution circuit 428 distributes two DC circuits 412 within a trunk to two different sectors of RRHs 416. More specifically, in TPU #1, power distribution circuit 428 distributes the −48V A1 of DC circuit A in trunk 444A-2 to sector #1 of six RRHs, and distributes the −48V B1 of DC circuit B in trunk 444A-2 to sector #2 of the other six RRHs.

According to another aspect, the set of trunks 444A-2, 444B-2, and 444C-2 between the BPU 410 and the TPUs 418 comprise aluminum conductors (e.g., 4/0 aluminum), rather than copper.

OVP units 420 are connected to both sides of the power distribution circuit 428. The −48 voltage DC in each DC circuit is connected to a respective OVP unit 420 and to a respective set of motorized circuit breakers 430 within the TPU. For example the −48V A1 is connected to a first OVP unit 420 and the −48V B1 is connected to a second OVP unit 420. In an example implementation, OVP unit 420 may comprise 25 mm Strikesorbs.

In one example, the motorized circuit breakers 430 may comprise a commercially available CBI RAU D7 breaker or the like. In one implementation, processor 127 (FIG. 1B) of the TPU 418 is connected to the motorized circuit breakers 430 via an electronic circuit (not shown). Responsive to a command to change the state of a designated motorized circuit breaker, the processor may send a logic high signal to a processor pin controlling the designated motorized circuit breaker to set the circuit breaker or a logic low signal to clear (or vice versa). Once the motorized circuit breaker detects this signal, the motorized circuit breaker changes to an opposite state from the current state.

In another implementation, instead of using motorized circuit breakers, standard or non-motorized circuit breakers that are in series with a set of relay switches may be used. In this implementation, each circuit breaker may be coupled to the power distribution circuit, and the relay switch is coupled between the circuit breaker and one of the RRHs. The circuit breaker interrupts the circuit only in case of overload or short circuit conditions. However, processor 127 (FIG. 1B) of the TPU 418 may be also connected to the relay switches via an electronic circuit (not shown). Responsive to a command to change the state of a designated RRH, the processor may send a logic high signal to an electronic circuit controlling the relay switch connected to the designated RRH to set the relay switch or a logic low signal to clear (or vice versa) and to open/close the corresponding relay switch. Once the relay switch detects this signal, the relay switch changes to an opposite state from the current state to turn-off/on the corresponding RRH. Thus, as used herein the phrase “motorized circuit breakers” is intended to refer to either implementation for brevity.

A method and system for providing a remotely operated power supply system for radios at a cellular site has been disclosed. Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

The terms “substantially,” “close,” “approximately,” “near,” and “about,” generally refer to being within +/−10% of a target value. Unless otherwise specified the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

For the purposes of the present disclosure, the phrases “A and/or B” and “A or B” mean (A), (B), or (A and B). For the purposes of the present disclosure, the phrase “A, B, and/or C” means (A), (B), (C), (A and B), (A and C), (B and C), or (A, B, and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

The terms “coupled,” “connected,” along with derivatives thereof are used herein. The term “coupled” or “connected” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” or “directly connected,” may mean that two or more elements are in direct contact with one another. The term “communicatively coupled” or “communicatively connected” may mean that two or more elements may be in contact with one another by a means of communication including through a wire or other interconnect connection, through a wireless communication channel or link, and/or the like.

The disclosed embodiments have been described in accordance with the implementations shown, and there could be variations to the embodiments, and any variations would be within the spirit and scope of the present invention. For example, the exemplary embodiment can be implemented using a combination of hardware, software, and computer-readable mediums containing program instructions. Software written according to the present invention is stored in some form of non-transitory computer-readable medium such as a memory or a hard disk and is to be executed by a hardware processor. Accordingly, many modifications may be made by one of ordinary skill in the art without departing from the spirit and scope of the appended claims.

We claim:

1. A system for powering a plurality of remote radio heads (RRHs), the system comprising:
a power cable comprising a plurality of DC circuits;
a base protection unit (BPU) located at a base location and coupled to one end of the power cable, the BPU comprising:
a base communication module comprising a user interface configured to receive a user command to turn on or off a designated RRH of the plurality of RRHs, the base communication module configured to transmit a command signal to implement the command; and
a top protection unit (TPU) located proximate to the plurality of RRHs and coupled between a second end of the power cable and the plurality of RRHs to power the plurality of RRHs, the TPU comprising:
a power distribution circuit connecting individual ones of the plurality of DC circuits to groups of the plurality of RRHs;
a set of motorized circuit breakers coupled between the power distribution circuit and the plurality RRHs; and
a top communication module that receives the command signal from the base communication module and in response, the TPU switches on or off a particular one of motorized circuit breakers connected to the designated RRH.

2. The system of claim 1, wherein each of the plurality of DC circuits comprises a −48 DC volt cable and a return cable.

3. The system of claim 2, wherein the −48 DC volt cable and a return cable between the BPU and the TPU comprise aluminum conductors.

4. The system of claim 1, wherein the BPU is further configured to receive another user command to view status data from the TPU.

5. The system of claim 1, wherein the BPU receives the user command from an operator either locally at the BPU or remotely over a network.

6. The system of claim 5, wherein the user interface comprises a display device to receive the user command from the operator locally, and at least one of a network management protocol and an embedded webpage provided by a webpage server for receiving the user command from the operator remotely over the network.

7. A power supply system for a plurality of remote radio heads (RRHs), the power supply system comprising:
a power cable from a power system, the power cable comprising a plurality of DC circuits;
a base protection unit (BPU) located at a base location and coupled to one end of the power cable, the BPU including a user interface having a display device; and
a top protection unit (TPU) located proximate to the plurality of RRHs on a structure and coupled between a second end of the power cable and the plurality of RRHs to power the plurality of RRHs, the TPU including:
a power distribution circuit connecting individual ones of the plurality of DC circuits to groups of the plurality of RRHs; and
a set of motorized circuit breakers coupled between the power distribution circuit and the plurality RRHs; and
a first memory storing status information associated with the set of motorized circuit breakers; and
wherein the BPU further includes a printed circuit board having a processor and a second memory, the second memory storing instructions, which when executed by the BPU cause the processor to:
periodically poll the TPU by transmitting one or more status command signals to the TPU requesting status data from the TPU;
receive one or more response messages from the TPU containing the status data stored by the TPU;
display the status data on the display device of the BPU;
responsive to receiving a user command from an operator via the user interface to turn on/off a designated RRH or motorized circuit breaker or to get the status information, transmit a corresponding command signal to the TPU; and
receive and display a response message from the TPU containing the status data stored by the TPU for the designated RRH or the motorized circuit breaker.

8. The power supply system of claim 7, wherein the command signal transmitted to the TPU requests status data for one or more of:
i. a number of the motorized circuit breakers,
ii. a current state of each of the motorized circuit breakers,
iii. −48 voltage value of each of the plurality of DC circuits input to the TPU,
iv. an ambient temperature of the TPU, and
v. a status of other tower devices.

9. The power supply system of claim 7, wherein the BPU receives the user command through entries made into the display device by the operator or entered through a network management protocol or an embedded webpage.

10. The power supply system of claim 7, wherein responsive to the designated motorized breaker failing to respond to the command signal, receiving and displaying an alarm or error message from the TPU on the display device or over a network connection to notify the operator.

11. A power supply system for a plurality of remote radio heads (RRHs), the power supply system comprising:
a power cable from a power system, the power cable comprising a plurality of DC circuits;
a base protection unit (BPU) located at a base location and coupled to one end of the power cable, the BPU includes a user interface having a display device; and
a top protection unit (TPU) located proximate to the plurality of RRHs on a structure and coupled between a second end of the power cable and the plurality of RRHs to power the plurality of RRHs, the TPU comprising:
a power distribution circuit connecting individual ones of the plurality of DC circuits to groups of the plurality of RRHs;
a set of motorized circuit breakers coupled between the power distribution circuit and the plurality RRHs, wherein a particular one of the motorized circuit breakers is set to “Off”, a corresponding one of the RRHs is turned off, and when the particular one of the motorized circuit breakers is set to “On”, the corresponding one of the RRHs is turned on; and
a memory to store respective states of the set of motorized circuit breakers.

12. The power supply system of claim 11, wherein the TPU further comprises a processor; and a memory storing instructions, which when executed by the TPU cause the processor to:
continually poll and store status data at set intervals, wherein the status data includes one or more of a number and state of the motorized circuit breakers, voltage of one or more of the plurality of DC circuits, and TPU temperature;
receive a command signal from the BPU, wherein the command signal includes one of: a request for one or more types of status data, to set or query a motorized circuit breaker state, and to initiate a TPU reboot;
responsive to determining that a particular motorized circuit breaker tripped, store a state of the particular motorized circuit breaker; and
responsive to receiving the command signal, execute and validate the received command signal, wherein the received command signal comprises one of: a first command to retrieve requested status data from the memory, a second command to set the state of a designated motorized circuit breaker, or a third command to query the state of the designated motorized circuit breaker.

13. The power supply system of claim 12, wherein the command signal from the BPU includes a user command made through entries into the display device or through a network management protocol or an embedded webpage by an operator.

14. The power supply system of claim 12, wherein validating the command signal comprises inspecting a data packet comprising the command signal by verifying start bytes, verifying packet length, and verifying a checksum.

15. The power supply system of claim 12, wherein responsive to the receiving the second command to set the state of a designated motorized circuit breaker to “On”, updating the memory to match an expected state for the designated motorized circuit breaker.

16. The power supply system of claim 12, further comprising responsive to the TPU powering on and booting up, the TPU sets all motorized circuit breakers to “Off”.

17. A system for powering a plurality of remote radio heads (RRHs), the system comprising:
a first trunk cable and a second trunk cable, each comprising a first DC circuit and a second DC circuit;
a base protection unit (BPU) located at a base location and coupled to one end of both the first trunk cable and the second trunk cable, the BPU comprising:
a base communication module comprising a user interface configured to receive a user command to turn on or off a designated one of the plurality of RRHs and to transmit the command in a command signal; and
a first top protection unit (TPU) and a second TPU, each located proximate to the plurality of RRHs, the first TPU connected to a second end of the first trunk cable, and the second TPU connected to a second end of the second trunk cable to power the plurality of RRHs, both the first TPU and the second TPU comprising:
a first independent DC distribution connecting the first DC circuit to a first sector of the plurality of RRHs;
a first set of circuit breakers coupled between the first independent DC distribution and the first sector of the plurality RRHs;
a second independent DC distribution connecting the second DC circuit to a second sector of the plurality of RRHs;
a second set of circuit breakers coupled between the second independent DC distribution and the second sector of the plurality RRHs; and
a top communication module that receives the command signal from the base communication module and in response, switches on or off a particular circuit breaker of the first set of circuit breakers or the second set of circuit breakers associated with the designated one of the plurality of RRHs.

18. The system of claim 17, further comprising: communication links between the BPU and each of the first TPU and the second TPU, wherein the communication links are implemented using a serial communications system.

19. The system of claim 18, wherein the serial communications system comprises RS-485.

20. The system of claim 17, wherein messages, including command signals, between the BPU and each of the first TPU and the second TPU, are transmitted using a data packet of 6-10 bytes.

21. The system of claim 20, wherein the data packet comprises: a preamble field, a data packet length field, a TPU addressing field, a command field, a response field, and a checksum field.

22. The system of claim 17, wherein the first set of circuit breakers are in series with a first set of relay switches, and the second set of circuit breakers are in series with a second set of relay switches.

23. A system for powering a plurality of remote radio heads (RRHs), the system comprising:
a power cable comprising a plurality of DC circuits;
a base protection unit (BPU) located at a base location and coupled to one end of the power cable, the BPU comprising:
a base communication module comprising a user interface configured to receive a user command to turn on or off a designated RRH of the plurality of RRHs, the base communication module configured to transmit a command signal to implement the command; and
a top protection unit (TPU) located proximate to the plurality of RRHs and coupled between a second end of the power cable and the plurality of RRHs to power the plurality of RRHs, the TPU comprising:
a power distribution circuit connecting individual ones of the plurality of DC circuits to groups of the plurality of RRHs;
a set of circuit breakers in series with respective relay switches, the set of circuit breakers coupled to the power distribution circuit, and the respective relay switches coupled between the set of circuit breakers and the plurality RRHs; and
a top communication module to receive the command signal from the base communication module and in response, the TPU switches on or off a particular one of the respective relay switches to turn-off/on the corresponding RRH.
